(19) United States
(12) Patent Application Publication
(10) Pub. No.: US 2017/0233274 A1
(43) Pub. Date: Aug. 17, 2017

(54) CONTAMINANT REMOVAL FROM WASTE WATER

(71) Applicant: PHILLIPS 66 COMPANY, HOUSTON, TX (US)

(72) Inventors: Varadharajan Kailasam, Bartlesville, OK (US); Katherine M. Smith, Tulsa, OK (US); Sriram Satya, Bartlesville, OK (US); Steve Marshall, Bartlesville, OK (US); Geetha Kothandaraman, Bartlesville, OK (US)

(73) Assignee: PHILLIPS 66 COMPANY, Houston, TX (US)

(21) Appl. No.: 15/262,543

(22) Filed: Sep. 12, 2016

Related U.S. Application Data
(60) Provisional application No. 62/296,368, filed on Feb. 17, 2016.

(51) Int. Cl. C02F 9/00; C02F 1/66; C02F 1/44; C02F 3/02; C02F 1/72; C02F 1/28

(52) U.S. Cl. CPC C02F 9/00; C02F 1/72; C02F 1/281; C02F 1/44; C02F 3/02; C02F 1/66; C02F 2101/106

(57) ABSTRACT

A method is disclosed for removing Se(IV) from aqueous solutions. The method begins by oxidizing an aqueous selenium solution with an aqueous oxidant to produce a Se(IV) solution. The Se(IV) solution is then contacted with a solid sorbent. The Se(IV) from the Se(IV) solution is then simultaneously adsorbed and encapsulated onto the solid sorbent to form an exhausted sorbent. The exhausted solid sorbent can then be disposed.

### CROSS-REFERENCE TO RELATED APPLICATIONS

This application is a non-provisional application which claims the benefit of and priority to U.S. Provisional Application Ser. No. 62/296,368 filed Feb. 17, 2016, entitled “Selenium Removal from Waste Water,” which is hereby incorporated by reference in its entirety.

### STATEMENT REGARDING FEDERALLY SPONSORED RESEARCH OR DEVELOPMENT

None.

### FIELD OF THE INVENTION

This invention relates to contaminant removal from refinery process water.

### BACKGROUND OF THE INVENTION

Contaminants in wastewater are a known problem, and selenium is a known contaminant. Selenium is a metalloid element with a well-documented impact upon health and the environment. Selenium cycles naturally within the environment however the balances can be significantly disrupted and influenced by anthropogenic activities including mining, minerals processing, agriculture, petroleum refining and coal-based power generation. Consequently, selenium levels within surface and groundwater are rapidly gaining global attention due to an established link between certain selenium species and environmental detriments including bioaccumulation and reproductive abnormalities within waterfowl and fish. To this end, industries that tend to generate significant levels of the most toxic of the selenium species, viz., selenocyanate, selenite and selenate, must take steps to ensure that their effluents meet permissible release standards. Of the technologies currently available, co-precipitation of selenium with metal salts (e.g. iron, copper, aluminum, etc.) appears to be the most common. However, potential drawbacks of this technique includes preferential applicability to select selenium species, the production of large volumes of sludge that must often be treated according to toxic disposal procedure and/or a general inability to meet the extremely low permissible limits being enacted by global environmental authorities.

The chemical properties of selenium however make its removal from solutions difficult and complex. Although insoluble in its elemental state, selenium has four oxidation states (−2, 0, +4, and +6), which allows it to readily form a number of compounds that are highly soluble and therefore very hard to remove from aqueous solutions. As a result, prior removal methods have been either disappointing or in some cases mostly ineffective. Thus there is a clear need for and utility in an improved method of removing selenium from aqueous solution.

Some technologies incorporate microorganisms to control the oxidation state of selenium and make the selenium more amenable to removal. Existing systems require multiple vessels that increase expense. These systems may also use anaerobic environments with dissolved oxygen concentrations less than 1 mg/L. At these dissolved oxygen concentrations, resulting water may have deleterious effects on aquatic life if they are discharged directly and added expense may be required to increase dissolved oxygen concentrations to suitable levels.

### BRIEF SUMMARY OF THE DISCLOSURE

A method is disclosed for removing Se(IV) from aqueous solutions. The method begins by oxidizing an aqueous selenium solution with an aqueous oxidant to produce a Se(IV) solution. The Se(IV) solution is then contacted with a solid sorbent. The Se(IV) from the Se(IV) solution is then simultaneously adsorbed and encapsulated onto the sorbent to form an exhausted sorbent. The exhausted solid sorbent can then be disposed.

In an alternate embodiment a method is taught consisting essentially of oxidizing an aqueous selenocyanate solution with an aqueous oxidant, at a temperature from about 20° C. to about 70° C. and a pH range from about pH 4 to about 7, to produce a Se(IV) solution. The Se(IV) solution is then contacted with a solid porous granular ferric hydroxide sorbent. The Se(IV) from the Se(IV) solution is then simultaneously adsorbed and encapsulated onto the solid porous granular ferric hydroxide sorbent to from an exhausted porous granular ferric hydroxide sorbent. The exhausted porous granular ferric hydroxide sorbent is then disposed.

In an alternate embodiment a method is taught comprising of oxidizing an aqueous selenocyanate solution with an aqueous oxidant, at a temperature from about 20° C. to about 70° C. and a pH range from about pH 4 to about 7, to produce a Se(IV) solution. A slurry solution can then be formed with the Se(IV) solution and an aqueous aerobic microorganism solution while contacting the slurry solution with a solid sorbent. It is envisioned that the aqueous aerobic microorganism solution contains a dissolved oxygen content greater than 1 mg/L and an oxygen reduction potential greater than −50 mV. The Se(IV) from the slurry solution is then simultaneously adsorbed and encapsulated onto the solid sorbent to form an exhausted sorbent. The exhausted sorbent and the aerobic microorganisms can then be disposed.

### BRIEF DESCRIPTION OF THE DRAWINGS

A more complete understanding of the present invention and benefits thereof may be acquired by referring to the following description taken in conjunction with the accompanying drawings in which:

FIG. 1 depicts the method.

FIG. 2 depicts conditions for oxidation of selenium to Se(IV).

FIG. 3 depicts the removal of Se(IV) using the solid granular ferric hydroxide sorbent.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

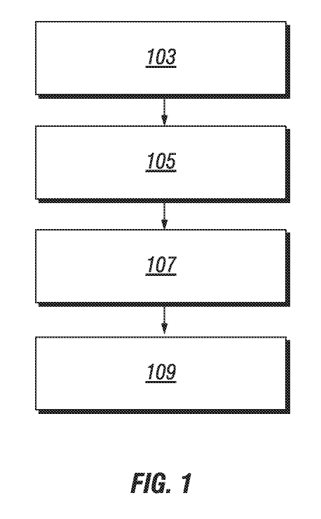

A method is disclosed for removing selenium from aqueous solutions. As shown in FIG. 1, the method begins by oxidizing an aqueous selenium solution with an aqueous oxidant to produce a solution that is predominantly Se(IV) 103. The Se(IV) solution is then contacted through a solid sorbent 105. The Se(IV) from solution is then simultaneously adsorbed and encapsulated onto the solid sorbent to form an exhausted sorbent 107. The exhausted sorbent can then be disposed 109.

In one embodiment the aqueous selenium solution comprises of aqueous selenocyanate (SeCN⁻) solution. The selenocyanate solution can be obtained from any known aqueous selenocyanate source. Examples of sources of aqueous selenocyanate solution can be from the processing of fossil feed stocks containing selenium (e.g. seleniferous crudes, shale oils and coals). The concentration of solutions the method is anticipated to handle can range from about 5 ppb to about 7 ppm or from about 3 ppb to about 10 ppm.

In one embodiment the Se(IV) solution also contains aerobic microorganisms. Aerobic microorganisms can be broadly defined as organisms that can survive and grow in an oxygenated environment such as obligate aerobes, facultative anaerobes, microaerophiles and aerotolerant anaerobes. Alternatively defined, an aqueous aerobic microorganism solution can be broadly defined as one that has a dissolved oxygen content greater than 1 mg/L and an oxygen reduction potential greater than −50 mV.

The aqueous oxidant for the present method can be any conventionally known oxidant capable of oxidizing the aqueous selenium solution. Examples of oxidants that can be used include NaOCl, H₂O₂, KMnO₄, ClO₂, or ozone.

The amount of aqueous oxidant used in the present method would be dependent upon the amount of selenium present in the aqueous selenocyanate solution. For the example of an aqueous selenocyanate solution the reaction with an aqueous oxidant could result in the production of an aqueous solution of predominantly Se(IV).

While the reaction pH would be dependent upon the reactants chosen in one embodiment it is envisioned that the oxidation pH would be from about pH 4 to about 7. In this embodiment no acid would be required to be added to the oxidation reaction. The reaction temperature would also be dependent upon the reactants chosen. In one embodiment it is envisioned that the oxidation temperature would be from 20° C. to 70° C.

The Se(IV) solution can then be contacted with a solid sorbent to form an exhausted sorbent. An exhausted sorbent does not necessarily mean a sorbent that can no longer adsorb Se(IV), but instead one that has been contacted with a Se(IV) solution. In one embodiment the solid sorbent could be granular ferric hydroxide. In other embodiments the sorbent can be a: Granular Ferric Hydroxide (GFH), 3-aminopropyl functionalized silica gel, 3-mercaptopropyl functionalized silica gel, polyethylenimine on silica gel, Resintech ASM10HP, Purolite ArsenX, Thiol SAMMS (THSL-07), Lanxess FO36, Lanxess M500, Thiol SAMMS (THSL-63), Fe-EDA SAMMS (FESL-63), Xtractite GN, Sulfur Modified Iron (SMI), ZrBPAP, Bayoxide E33, Dow Absorbsia ADS500, or combinations thereof. In this embodiment the pH of the Se(IV) solution would not be adjusted via any chemical addition after the oxidation reaction, and the pH of the solution flowing through the solid sorbent would be in the range from about pH 4 to about 7. It is envisioned that the selenium could simultaneously adsorb onto or be encapsulated on the solid sorbent. In one embodiment the idea of encapsulating the selenium includes immobilization of the selenium. In this embodiment the selenium is not encapsulated by the sorbent but instead it is secured to the sorbent. In the scenario where the Se(IV) solution also contains aerobic microorganisms, this simultaneous adsorbing and encapsulating can be done in the presence of the aerobic microorganisms.

In one alternate embodiment, a slurry solution of Se(IV) solution and an aqueous aerobic microorganism solution is produced. In this embodiment, the simultaneous adsorbing and encapsulating of the Se(IV) can be done in the presence of the aerobic microorganisms.

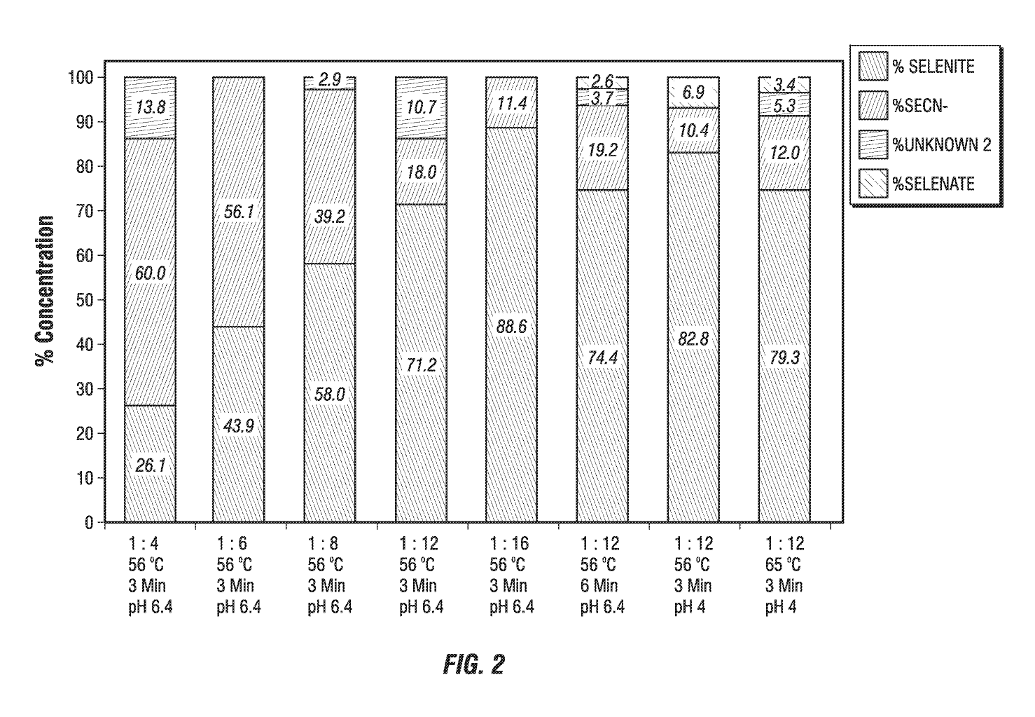

In the final step, in one embodiment the removal of the selenium and the exhausted sorbent can be accomplished without the need of filtering, pressing, or caking as is typically required for co-precipitation technologies. The exhausted sorbent can be disposed of as waste. In another embodiment the removal of the selenium and the solid sorbent can be accomplished through the use of solids removal techniques such as clarification or membrane filtration. It is also envisioned that a scenario can occur where the aerobic microorganisms are present that the aeobic microorganisms are separated prior to disposing the exhausted sorbent. This separation step can be done with any known process or device including a membrane, gravity separation or even a clarifier. The aeobic microorganisms can then be simultaneously disposed with the exhausted sorbent. As shown in FIG. 2, aqueous selenocyanate was reacted with an aqueous oxidant (NaOCl), resulting in the formation of a solution containing predominantly Se(IV). It can be seen from this figure that varying reaction conditions (pH, temperature, time, NaOCl concentration) results in different distributions of selenium species, and that pH adjustment with acid addition is not required for selenocyanate oxidation to Se(IV).

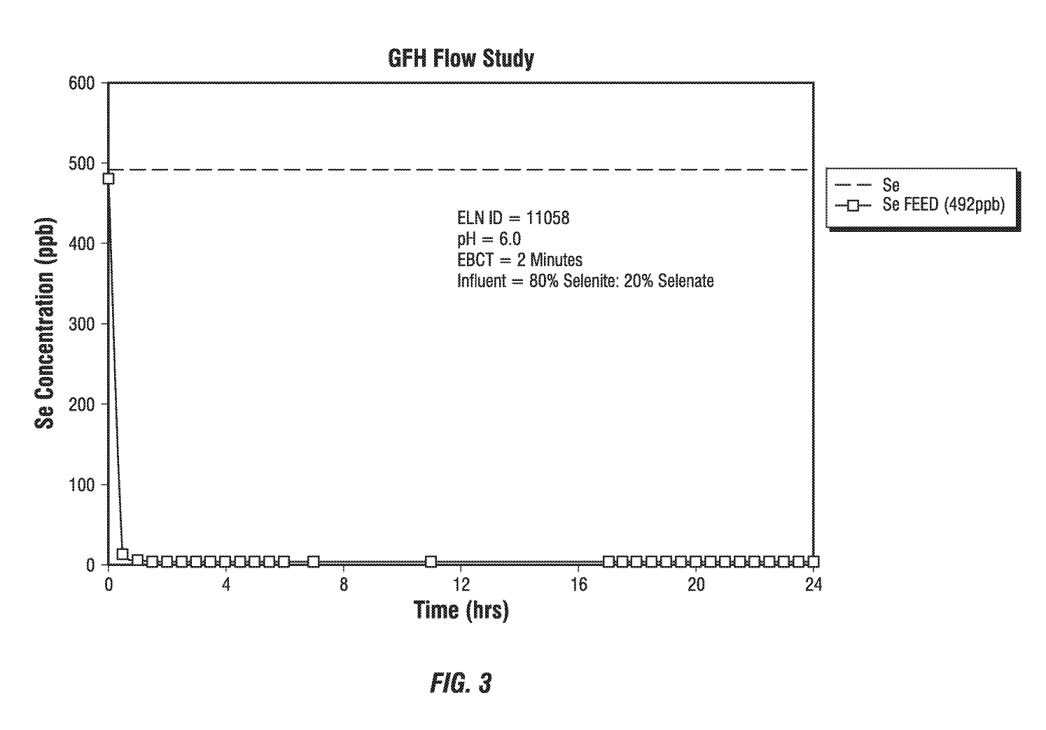

As shown in FIG. 3, an 80% Se(IV): 20% Se(VI) mixture is flowed through a solid granular ferric hydroxide sorbent bed. It can be shown from this figure that the residence time needed for the Se(IV) and Se(VI) to adsorb onto the granular ferric hydroxide sorbent was less than 10 minutes. The quickness of this heterogeneous reaction makes it ideal for either a batch or flow process.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims, while the description, abstract, and drawings are not to be used to limit the scope of the invention. The invention is specifically intended to be as broad as the claims below and their equivalents.

1. A method comprising:
oxidizing an aqueous selenium solution with an aqueous oxidant to produce a Se(IV) solution;
contacting the Se(IV) solution with a solid sorbent;
simultaneously adsorbing and encapsulating Se(IV) from the Se(IV) solution onto the solid sorbent to form an exhausted sorbent; and
disposing of the exhausted sorbent.

2. The method of claim 1, wherein the Se(IV) solution contains aerobic microorganisms.

3. The method of claim 2, wherein both the aerobic microorganisms and the exhausted sorbent are disposed.

4. The method of claim 1, wherein the simultaneously adsorbing and encapsulating Se(IV) from the Se(IV) solution onto the solid sorbent to form an exhausted sorbent occurs in the presence of aerobic microorganisms.

5. The method of claim 1, wherein the aqueous selenium solution is an aqueous selenocyanate solution.

6. The method of claim 1, wherein the selenium solution comprises of Se(IV).

7. The method of claim 1, wherein the solid sorbent is selected from the group consisting of: Granular Ferric Hydroxide , ASM10HP available from Resintech, ArsenX available from Purolite, FO36 available from Lanxess, M500 available from Lanxess, Thiol SAMMS (THSL-63), Fe-EDA SAMMS (FESL-63), Xtractite GN, Sulfur Modified Iron, ZrBPAP, Bayoxide E33, Absorbsia ADS500 available from Dow, or combinations thereof.

8. The method of claim 1, wherein the oxidant is selected from the group consisting of: NaOCl, H₂O₂, KMNO₄, ClO₂, ozone and combinations thereof.

9. The method of claim 1, wherein the oxidation occurs at a pH range from about pH 4 to about 7.

10. The method of claim 1, wherein the oxidation occurs at a temperature range from about 20° C. to about 70° C.

11. The method of claim 1, wherein the oxidation reaction consists of the aqueous selenium solution and the aqueous oxidant.

12. A method consisting essentially of:
oxidizing an aqueous selenocyanate solution with an aqueous oxidant, at a temperature from about 20° C. to about 70° C. and a pH range from about pH 4 to about 7, to produce a Se(IV) solution;
contacting the Se(IV) solution through a solid porous granular ferric hydroxide sorbent;
simultaneously adsorbing and encapsulating the Se(IV) from the Se(IV) solution onto the solid porous granular ferric hydroxide sorbent to form an exhausted porous granular ferric hydroxide sorbent; and
disposing the exhausted porous granular ferric hydroxide sorbent.

13. The method of claim 12, wherein the Se(IV) solution contains aerobic microorganisms.

14. The method of claim 13, wherein the aerobic microorganisms are separated prior to disposing the exhausted sorbent.

15. The method of claim 12, wherein the simultaneously adsorbing and encapsulating Se(IV) from the Se(IV) solution onto the solid sorbent to form an exhausted granular ferric hydroxide occurs in the presence of aerobic microorganisms.

16. A method comprising of:
oxidizing an aqueous selenocyanate solution with an aqueous oxidant, at a temperature from about 20° C. to about 70° C. and a pH range from about pH 4 to about pH 7, to produce a Se(IV) solution;
forming a slurry solution of the Se(IV) solution with an aqueous aerobic microorganism solution while contacting the slurry solution with a solid sorbent wherein the aqueous aerobic microorganism solution contains a dissolved oxygen content greater than 1 mg/L and an oxygen reduction potential greater than −50 mV;
simultaneously adsorbing and encapsulated the Se(IV) from the slurry solution onto the solid sorbent to form an exhausted sorbent;
separating the aerobic microorganisms from the slurry solution; and
disposing the exhausted sorbent and the aerobic microorganisms.

17. The method of claim 16, wherein a membrane is used to separate aerobic microorganisms from the slurry.

18. The method of claim 16, wherein gravity separation is used to separate the aerobic microorganisms from the slurry.

19. The method of claim 18, wherein the gravity separation is a clarifier.
